(19) United States
(12) Patent Application Publication
(10) Pub. No.: US 2015/0120620 A1
(43) Pub. Date: Apr. 30, 2015

(54) SYSTEMS AND METHODS FOR ASSESSING ALIGNMENT OF AN ENTITY

(71) Applicants: Brett Aaron Rutledge, Port Melbourne (AU); Susan Patty Lindsay, Queenstown (NZ); Ruth Vivienne Fisher, Christchurch (NZ)

(72) Inventors: Brett Aaron Rutledge, Port Melbourne (AU); Susan Patty Lindsay, Queenstown (NZ); Ruth Vivienne Fisher, Christchurch (NZ)

(21) Appl. No.: 14/066,549

(22) Filed: Oct. 29, 2013

(30) Foreign Application Priority Data
Oct. 29, 2013 (NZ) 617170

(51) Int. Cl. G06N 5/04; G06N 99/00

(52) U.S. Cl. CPC G06N 5/04; G06N 99/005
USPC 706/12; 706/46; 706/52

(57) ABSTRACT

The present invention relates to a systems, methods, and articles of manufacture for enabling assessment of alignment of an entity. In one embodiment, content associated with the entity and comprising text, and responses to questions presented to stakeholders of the entity are received and processed to derive data sets of contextually significant words or phrases for the content and responses respectively. The contextually significant words or phrases of the respective data sets are correlated and output.

### BACKGROUND OF THE INVENTION

1. Field of the Invention

The present invention relates generally to business methods and analytical tools. More specifically, the present invention is related to systems and methods for assessing alignment of an entity.

2. Description of Related Art

Organizations are continuously looking to identify means for improving performance or effectiveness. In some cases, this includes recognizing barriers to an organization's growth.

In particular, it has been identified that if there is a lack of alignment between how an enterprise is perceived, how it behaves and what employees, customers or suppliers believe then this is indicative of a breakdown in culture that leads directly to poor performance, broken relationships and distrust.

While this is somewhat self-evident, objectively and accurately assessing alignment is challenging. Typically, business consultants are hired to research and analyze the issue in order to provide strategic guidance.

However, an inherent problem with research that tries to measure what people think of any product, service, company, management team or other aspect of the organization is that in using conventional tools like polls, surveys, Likert scales, or similar scoring devices, the researcher or analyst sets the base presumptions. This creates an unavoidable bias in the findings and limits the scope of what can be discovered at the same time.

Specific issues include factors such as: knowing what to ask about; how the attributes to be measured should be chosen; how many attributes should be chosen; the researcher being unable to know that all of the relevant aspects have been included and being unaware of what has been missed. Further, the choices made by the researcher(s) reflect their own preferences, views about the world, opinions regarding what is and is not important, and what resources are available to do the research.

Regardless of the analyst's abilities, by definition, it is always the researchers' choices about such factors which direct the research and therefore determine much of the answer. As a result, important factors are missed, data gets skewed and the analysis that emerges does not accurately describe what the subject thinks or the attitudes they have.

All references, comprising any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art.

Throughout this specification, the word “include”, or variations thereof such as “includes” or “including”, will be understood to imply the inclusion of a stated element, integer or step, or group of elements integers or steps, but not the exclusion of any other element, integer or step, or group of elements, integers or steps unless explicitly stated.

Further aspects and advantages of the present invention will become apparent from the ensuing description which is given by way of example only.

### SUMMARY OF THE INVENTION

According to an aspect of the present invention there is provided a system enabling assessment of alignment of an entity, including a description importing module configured to receive content associated with the entity comprising text; an attitude importing module configured to receive responses to questions presented to stakeholders of the entity; a text analyzer module configured to process the content and responses to derive data sets comprising contextually significant words or phrases for the content and responses respectively; and an alignment assessment module configured to correlate the significant words or phrases of the respective data sets and output a correlated set of significant words or phrases.

According to an aspect of the present invention there is provided a method of enabling assessment of alignment of an entity, including: receiving content associated with the entity and comprising text; receiving responses to questions presented to stakeholders of the entity; processing the content and responses to derive data sets comprising contextually significant words or phrases for the content and responses respectively; and correlating the contextually significant words or phrases of the respective data sets and outputting a correlated set of significant words or phrases.

According to an aspect of the present invention there is provided an article of manufacture having computer storage medium storing computer readable program code executable by a computer to implement a method of enabling assessment of alignment of an entity, comprising: computer readable program code receiving content associated with the entity and comprising text; computer readable program code receiving responses to questions presented to stakeholders of the entity; computer readable program code processing the content and responses to derive data sets comprising contextually significant words or phrases for the content and responses respectively; and computer readable program code correlating the significant words or phrases of the respective data sets and outputting a correlated set of significant words or phrases.

Reference to an entity should be understood to mean anything with a distinct and independent identity. It is envisaged that the present invention will have particular application to assessing alignment of an organization—especially a business. However, it should be appreciated that this is not intended to be limiting and the entity may be, for example, a person, a group, or a population.

Reference to alignment should be understood to mean a measurement of the degree of coherence between two or more of an entity's vision, mission, execution, values, beliefs, delivery, brand, culture, behaviors, marketing, or strategy. Alignment may encompass coherence between how an entity wants to be perceived, how it projects itself internally and/or externally, and how it is perceived by various stakeholders.

Reference to a stakeholder should be understood to mean any person or other entity which can affect or be affected by the actions of the entity. For example, the stakeholder may be staff, customers, suppliers, students, members, investors, clients, and even the general public.

Reference to contextually significant words or phrases should be understood to mean those words and phrases for which the likelihood of being relevant to the subject at hand is beyond the probability of chance.

Content may be received by the description importing module through a variety of means. For example, it is envisaged that documents may be manually uploaded or transferred to directories accessible by the description importing module.

The content may be converted to a desirable format—particularly machine readable text—via any suitable means known in the art, whether manual or automated.

In a preferred embodiment, the description importing module is configured to obtain the content. For example, the description importing module may be configured to “crawl” an entity's database to automatically obtain the content. It should be appreciated that this process may be restricted to designated addresses or locations. Similarly, the description importing module may be configured to obtain content from websites—for example a set of URL's designated for data collection.

In a preferred embodiment, the description importing module is configured to enable differentiation between internal and external content.

Internal content may comprise any materials distributed or available within the entity, but not distributed externally. For example, the internal content may comprise one or more of: staff newsletters, policies and procedures, induction documents, training material, memos, key performance indicators, staff presentations, or intranet content. It is envisaged that the words derived from this material may be particularly useful in identifying the messages an entity's leadership conveys to staff regarding expectations around culture and performance.

External content may comprise any materials distributed to, or otherwise accessible by, people outside the entity—generally the wider public, but potentially specific stakeholders such as suppliers or customers. For example, the external content may comprise one or more of: brochures, annual reports, press releases, articles, advertising, marketing collateral, or website content. It follows that words derived from this material may be particularly useful in identifying messages conveyed to the public and external stakeholders regarding the entity.

Differentiating between internal and external content may be achieved using any suitable means known to a person skilled in the art. For example, the content may be stored to preconfigured directories, or given a designation or label prior to delivery to the description importing module.

In a preferred embodiment, the attitude importing module is configured to receive the responses from online questionnaires. Such questionnaires are well known in the art of eliciting responses from a target audience, and are envisaged to provide a means for obtaining the responses in an electronic format which may be easily processed by the text analyzer module.

However, it should be appreciated that this is not intended to be limiting, and questions may be presented and/or the responses received in other formats. For example, the questions and/or responses may be oral, written, or electronic text. It is envisaged that oral or hand-written responses may be converted to digital text manually, or using any suitable automated means known in the art.

In a preferred embodiment, a question may comprise at least one open ended question. Such an open ended question encourages the respondent to provide their description of perception or experience of an area of interest, avoiding leading the respondent to a particular answer.

Preferably the area of interest relates to one of experience, environment, communication, leadership, loyalty, advocacy, purpose, or view of future (for example as it relates to optimism or pessimism).

A set of questions covering the range of areas of interest may be maintained. In a preferred embodiment, the question to be presented is selected based on the area of interest for assessment, and the identity of the entity inserted into an identification field within the question before presentation to stakeholders.

In a preferred embodiment, the same question is presented to stakeholders at a later date, and the responses processed by the text analyzer module to derive a current set of contextually significant words or phrases.

This enables a comparison to be made between the contextually significant words or phrases at different times, and the significance of any differences assessed.

Because alignment is specific to the current context of the entity, a direct comparison may be made which is not impacted by changes in surrounding variables—either the entity is more aligned, or it is not.

Preferably the responses are anonymous in order to encourage candid discussion without the influence of the fear of prejudice or hope of favor.

Processing the content and responses to derive the data sets comprising the significant words or phrases in context may comprise a plurality of analytical and filtering processes.

The process may comprise one or more of the following:
Sentence analysis, breaking the text into sentences that can be tracked and analyzed with the individual words in context.
Stop word filtering, which discards words designated as being irrelevant—for example, “a”, “the”, or the entity's name. It should be appreciated that the stop word filtering may be trained or refined over time. It is envisaged that different collections of stop words may be maintained and developed for application dependent on factors such as the industry or location in which the entity operates.
Synonym filtering, to identify equivalence of words and more accurately determine frequency of that word.
Word stemming, to return the root of a word and facilitate ease of classification and comparison. For example, “words” may be returned as “word”, or “toasted” as “toast”.
Sentiment analysis to determine the sense of the word or phrase with regard to polarity.
Part of Speech analysis to identify the lexical category to which a word belongs (for example, noun or adjective).
Tone of Comments analysis to assess the attitude of the author, particularly with regard to emotional context.
Document Importance in the context of the collection of content. For example, an internal document such as a memo may be more widely read than a rarely referenced human resources document, and thus given a greater importance. As an example in the context of external content—the importance of an article published in a newspaper may be determined based on the circulation of the newspaper, or the prominence of the article within the newspaper.
Position in document. For example, if the word or phrase is located in the title of a document, it may be considered of greater contextual significance than if it had been located in the main body.

In a preferred embodiment, deriving the contextually significant words or phrases comprises application of Bayesian contextual analysis after at least one iteration of the plurality of analytical and filtering processes.

The inventors have identified that the application of Bayesian analytical techniques is particularly useful for obtaining unbiased data for the assessment alignment based on the words used in the content and responses which express the implicit cognition of stakeholders associated with the entity. Implicit cognition refers to unconscious influences such as knowledge, perception, or memory, that influence a person's behavior, even though they themselves have no conscious awareness of those influences.

In particular, Bayesian inference assists in solving the problem of bias in the collection of data, by allowing for informative priors to be introduced to the analytical and filtering processes to inform them of context.

Ultimately, the Bayesian contextual analysis evaluates consensus: whether the significance being ascribed by the analytical and filtering processes is based on consideration of the words or phrases in context. The Bayesian contextual analysis may be used to train the analytical and filtering processes after each iteration.

For example, the word “audit” may appear frequently in external content produced by an accounting firm. A natural assumption would be that “audit” is not significant, and simply a term frequently used in the industry. However, the term cannot simply be discarded through inclusion in the stop word filtering, as the accounting firm may have a service line associated with auditing and inclusion of this service in the assessment may be desired. Bayesian contextual analysis may be used to determine the probability of the term being used in a particular context, and thus its significance for the purpose of analysis.

Using the same example, a government audit may have been performed recently. The Bayesian contextual analysis allows for determination that the term “audit” may have been used in reference to this particular event, and places a lower significance on instances of the word occurring in the context of reporting the government audit, or completely distinguishes them from use in other contexts.

In a preferred embodiment, each word or phrase is stored with identification of their origin and date of creation. As an example, a word obtained from a webpage might be stored with the URL from which it was accessed.

As a further example, a word may be identified as being found in a particular response. This may be useful for analyzing the word or phrase in the context of the demographic of the stakeholder who provided the response.

In a preferred embodiment, the content and responses are processed by the text analyzer module as they are received by the description importing module and attitude importing module respectively.

The theory of diminishing returns may be applied to ensure that all contextually significant words have been included in the analysis. At the point at which no significant new words are added by processing of additional responses or content, or training of the filters, a degree of confidence that any analysis is working with a complete population is achieved. Further, resources which might otherwise be spent processing statistically insignificant content and responses may be saved.

Determination of contextual significance and comparison of the words may be achieved, for example, utilising Spearman's rank correlation coefficient to measure statistical dependency between the sets of data. It should be appreciated that any other suitable statistical methods known to a person skilled in the art may be implemented.

In a preferred embodiment, the alignment assessment module is configured to the output correlated set of statistically significant words or phrases in the form of a text map. Reference to a text map should be understood to mean a visual representation of the words and/or phrases comprising the data set in which the words of greatest contextual significance are given greatest visual prominence. This prominence is typically achieved using size, but other aspects such as colour and location in the map may also be used.

Presenting the words in the form of a text map is considered to be particularly useful for assessing alignment. The visualization clearly illustrates the most contextually significant words for ready comparison with hoped for or expected descriptions.

It should be appreciated that this is not intended to be limiting, and that the correlated set of statistically significant words or phrases may be output in other forms—whether a visual representation of otherwise.

In another embodiment, the alignment assessment module may be configured to determine an alignment value reflecting the degree of correlation between the statistically significant words or phrases of the respective data sets.

Such a value may be used to establish a benchmark, and used in subsequent assessments to determine whether the organization is currently more aligned than it was in the previous measurement period.

According to an aspect of the present invention there is provided a method of enabling assessment of alignment of an entity, comprising: receiving content associated with the entity and comprising text; receiving responses to questions presented to stakeholders of the entity; processing the content and responses to derive data sets comprising contextually significant words or phrases for the content and responses respectively; and correlating the statistically significant words or phrases of the respective data sets, and determining a score reflecting alignment of the respective datasets.

It should be appreciated that while the present invention has been described in relation to a wider system in which contextually significant words or phrases for both the content and responses are determined and correlated, for the purposes of enabling a determination of alignment, this is not intended to be limiting. Individual elements within the system may be applied independently or in combination with other elements for other purposes, examples of which will be discussed herein.

According to an aspect of the present invention there is provided a system enabling assessment of alignment of an entity's desired brand representation with its external content, comprising: a description importing module configured to receive external content associated with the entity comprising text; a text analyzer module configured to process the content to derive a data set comprising contextually significant words or phrases for the content; and an alignment assessment module configured to output the data set.

According to an aspect of the present invention there is provided a method of enabling assessment of alignment of an entity's desired brand representation with its external content, comprising: receiving external content associated with the entity comprising text; processing the content to derive a data set comprising contextually significant words or phrases for the content; and outputting the data set.

According to an aspect of the present invention there is provided an article of manufacture having computer storage medium storing computer readable program code executable by a computer to implement a method of enabling assessment of alignment of an entity's desired brand representation with its external content, comprising: computer readable program code receiving external content associated with the entity comprising text; computer readable program code processing the content to derive a data set comprising contextually significant words or phrases for the content; and computer readable program code outputting the data set.

An entity's external content has a large influence on how the entity is perceived and judged by external stakeholders. An entity's brand representation is made through the words of that content. By including a substantive proportion of the words—not just the ones that the entity is comfortable with or the ones that an individual might consider appropriate—in the assessment of the present invention, a more accurate representation of the brand may be determined.

As discussed previously, it is envisaged that presentation of the data set as a text map may be particularly effective for visualizing the words determined to characterize the entity's external content.

By enabling assessment of alignment, steps can be taking to modify or recreate external content to better align the external content with the desired brand representation.

Similarly, an entity's internal content may be assessed to evaluate alignment between the messages conveyed by that message with the entity's desired internal culture.

According to an aspect of the present invention there is provided a system enabling assessment of alignment of an entity's desired culture with its internal content, comprising: a description importing module configured to receive internal content associated with the entity comprising text; a text analyzer module configured to process the content to derive a data set comprising contextually significant words or phrases for the content; and an alignment assessment module configured to output the data sets.

According to an aspect of the present invention there is provided a method of enabling assessment of alignment of an entity's desired culture with its internal content, comprising: receiving internal content associated with the entity comprising text; processing the content to derive a data set comprising contextually significant words or phrases for the content; and outputting the data set.

According to an aspect of the present invention there is provided an article of manufacture having computer storage medium storing computer readable program code executable by a computer to implement a method of enabling assessment of alignment of an entity's desired brand representation with its external content, comprising: computer readable program code receiving internal content associated with the entity comprising text; computer readable program code processing the content to derive a data set comprising contextually significant words or phrases for the content; and computer readable program code outputting the data set.

In a preferred embodiment, the system may include a content readability module. As the external and/or internal content is already being evaluated with the potential for modification or replacement, it is envisaged that the application of a readability test—for example the Flesch Reading Ease or Flesch-Kincaid Grade Level tests—may be complementary.

According to an aspect of the present invention there is provided a system enabling assessment of alignment of an entity's desired perception of brand or culture with perception by stakeholders, comprising: an attitude importing module configured to receive responses to questions presented to stakeholders of the entity; a text analyzer module configured to process the responses to derive a data set comprising contextually significant words or phrases for the responses; and an alignment assessment module configured to output the data sets.

According to an aspect of the present invention there is provided a method of enabling assessment of alignment of an entity's desired perception of brand or culture with perception by stakeholders, comprising: receiving responses to questions presented to stakeholders of the entity; processing the responses to derive a data set comprising contextually significant words or phrases for the responses; and outputting the data set.

According to an aspect of the present invention there is provided an article of manufacture having computer storage medium storing computer readable program code executable by a computer to implement a method of enabling assessment of alignment of an entity's desired perception of brand or culture with perception by stakeholders, comprising: computer readable program code receiving responses to questions presented to stakeholders of the entity; computer readable program code processing the responses to derive a data set comprising contextually significant words or phrases for the responses; and computer readable program code outputting the data set.

It should be appreciated that a differentiation may be made between the responses of internal and external stakeholders. Focusing on the responses of internal stakeholders may reveal the actual perception of culture, while the significant words of the external stakeholders' responses may reveal their perception of the entity's brand.

For a firmware and/or software (also known as a computer program) implementation, the techniques of the present invention may be implemented as instructions (for example, procedures, functions, and so on) that perform the functions described. It should be appreciated that the present invention is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present invention may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

### BRIEF DESCRIPTION OF THE DRAWINGS

Further aspects of the present invention will become apparent from the ensuing description which is given by way of example only and with reference to the accompanying drawings in which:

FIG. 1A presents a schematic diagram of an exemplary system in which embodiments of the present invention may be implemented;

FIG. 1B presents a schematic diagram of an exemplary sub-system according to one embodiment of the present invention;

FIG. 2A presents a flow diagram illustrating a method according to one exemplary embodiment of the present invention;

FIG. 2B presents a flow diagram illustrating an exemplary sub-process within the method;

FIG. 3 presents a flow diagram illustrating another exemplary method according another embodiment of the present invention;

FIG. 4 presents a flow diagram illustrating another exemplary method according another embodiment of the present invention, and

FIG. 5 illustrates an exemplary visual presentation of data produced according to embodiments of the present invention.

### DETAILED DESCRIPTION

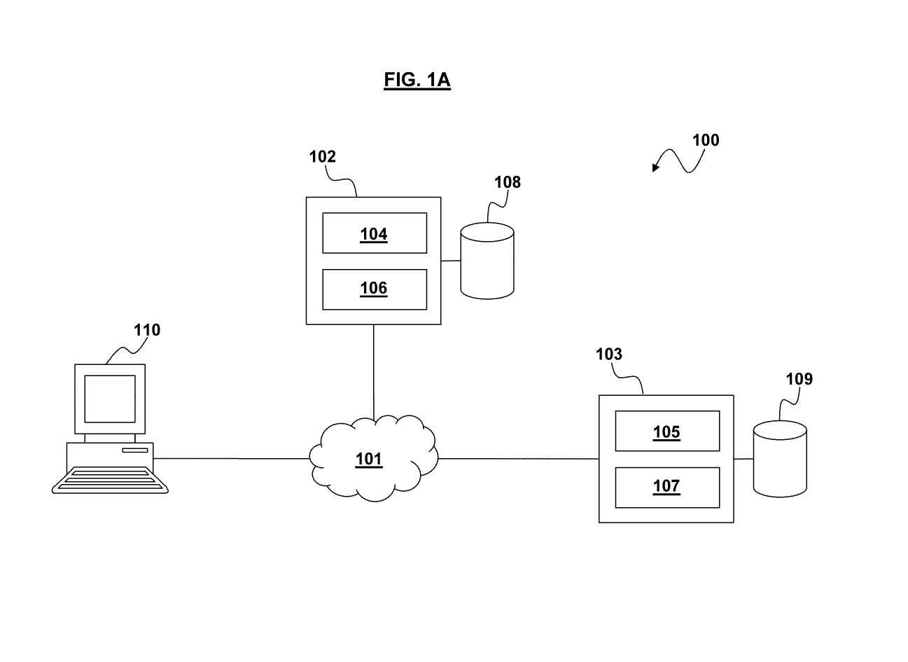

FIG. 1A illustrates a system 100 in which various embodiments of the present invention may be implemented.

The various components of the system 100 communicate over a network 101. In one embodiment, the network 101 shown comprises the Internet. In other embodiments, other networks, such as an intranet, WAN, or LAN may be used. It should be appreciated that the network 101 may comprise a combination of suitable networks to establish a communication link.

The system 100 comprises an analysis server device 102, and entity server device 103, connected to the network 101.

The server devices 102, and 103 shown in FIG. 1 each contain a processor 104 and 105 respectively, coupled to a computer readable medium, such as memory 106 and 107 respectively. Server devices 102 and 103 also communicate with computer readable medium storage devices 108 and 109 respectively, such as magnetic disk storage devices. Server devices 102 and 103, depicted as single computer system, may be implemented as a network of computer processors. Examples of server devices 102 and 103 are servers, mainframe computers, networked computers, processor-based devices and similar types of systems and devices.

In an exemplary embodiment, the functionality hosted by the server devices 102 and 103 may comprise web or HTTP servers, FTP servers as well as, without limitation, web pages and applications implemented using Common Gateway Interface (CGI) script, PHP Hyper-text Preprocessor (PHP), Active Server Pages (ASP), Hyper Test Markup Language (HTML), or Extensible Markup Language (XML), Java, JavaScript, Asynchronous JavaScript and XML (AJAX), and the like.

Client devices, such as workstation 110 are also capable of connecting to the network 101.

Other examples of client devices are digital assistants, personal digital assistants, cellular phones, smart phones, pagers, laptop computers, Internet appliances, and other processor-based devices. In general, a client device may be any type of suitable processor-based platform that is capable of connecting to the network 101 to deliver content to analysis server devices 102. The client devices may also comprise a number of external or internal devices such as a mouse, a touchpad or screen, a camera, a microphone, a keyboard, a display, or other input or output devices. Client devices may operate on any operating system, such as Microsoft™ Windows™ or Linux.

FIG. 1B illustrates functional modules of the analysis server device 102.

Web crawler module 111, survey manager module 112, system access management module 113, and manual document feed module 114 facilitate the collection of documents and other inputs in relation to the entity to be assessed.

Text analyzer module 115 processes the text, and data manager module 116 manages handling of the data produced—whether further processing by Bayesian analyzer 117, storage in document repository 118 and/or database 119, or access and/or configuration by administration interface 120 or consultant interface 121.

More detailed description of the operation of the system 100 is outlined below.

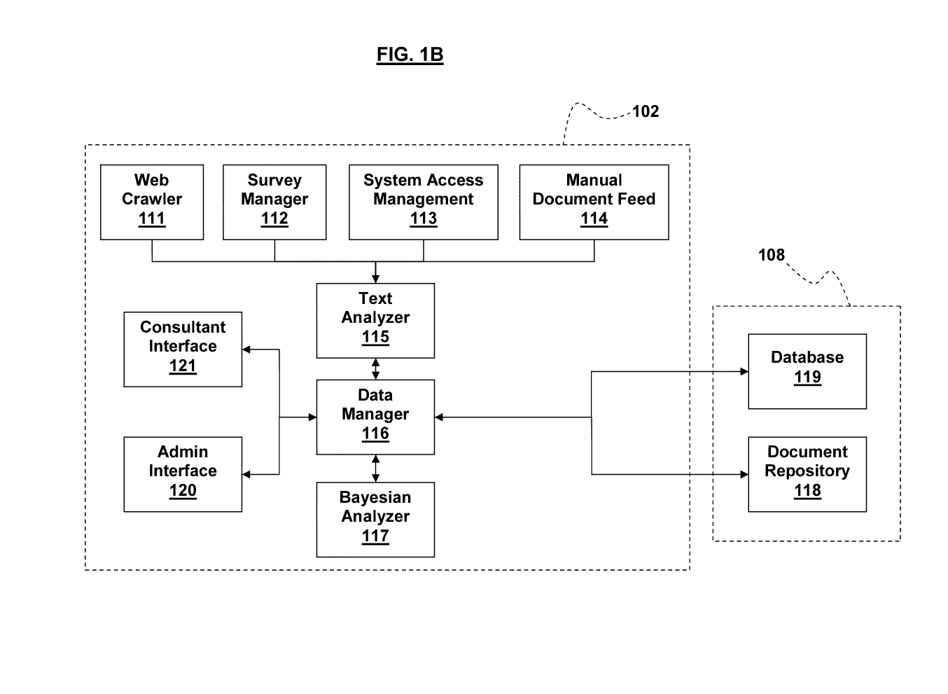

FIG. 2A shows a process flow 200 of the present invention. In step 201, the analysis server device 102 receives external and internal content. The external content comprises, for example, one or more of: brochures, annual reports, press releases, articles, advertising, marketing collateral, or website content. The internal content comprises, for example, one or more of: staff newsletters, policies and procedures, induction documents, training material, memos, key performance indicators, staff presentations, or intranet content.

Website content may be obtained using web crawler module 111, configured to access designated URLs and extract core data for analysis. Designation of the URL's may be set through the administration interface 120.

The system access management module 112 may obtain content by accessing entity server device 103 and crawling designated directories, or through content being delivered from a software agent on the entity server device 103.

Additionally, or alternatively, content may be manually feed into the system 100 via manual document feed module 114—for example scanning or uploading documents to the module.

In step 202, the analysis server device 102 receives responses to questions presented to stakeholders of the entity, via survey manager module 112. In some embodiments, in addition to receiving the responses, the survey manager module 112 may be configured to issue the questions to the stakeholders, for example in the form of an online questionnaire accessed by workstation 110. The survey manager module 112 preferably includes means for categorizing the stakeholder as an internal stakeholder (such as an employee), or an external stakeholder (such as a customer), along with recording demographics such as age and gender.

In step 203 the content and responses are passed to the text analyzer 115, which processes the content and responses to derive data sets comprising contextually significant words or phrases for the content and responses respectively. See FIG. 2B, as described below, for an expanded discussion on step 203.

In step 204 the content, responses, words, and phrases are stored in the document repository 118 and database 119. Each element is tagged with details such as its source, date created, category (for example, external content or internal content), and characteristics identified during processing in step 203.

In step 205 the contextually significant words or phrases of the respective data sets are correlated to produce a correlated set of significant words or phrases.

In step 206 the correlated set of significant words or phrases are transmitted to the consultant interface 121 for display in the form of a text map. The size of words or phrases displayed is based on relative significance, with those of greatest significance being largest as a means of emphasizing this. Words of relatively equal significance may be group—for example in close proximity to each other in the map, and/or assigned an equal size.

Returning to step 203, FIG. 2B illustrates sub-processes within step 203 with regard to filtering and analyzing the content and responses.

In step 207, one or more of the following processes are applied to the content and responses: sentence analysis, stop word filtering, synonym filtering, word stemming, sentiment analysis, Part of Speech analysis, Tone of Comments analysis, Document Importance, and Position in document.

In step 208, the data produced by the processing in step 207 is reviewed to assess whether the population of contextually significant words or phrases is complete.

If not, or contextual irregularities are identified, Bayesian inference is applied to train the processes applied in step 207, and those processes run again.

Once the population is determined to be complete, the content, responses, words, and phrases are stored in the document repository 118 and database 119 in step 204,

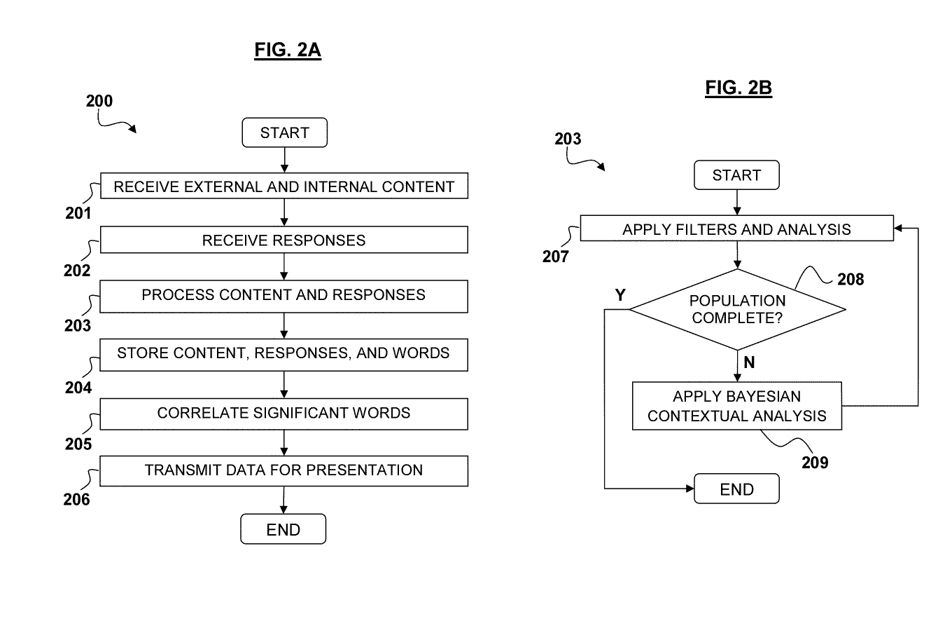

FIG. 3 shows a process flow 300 of the present invention for enabling assessment of alignment of an entity's desired brand representation with its external content.

In step 301, the analysis server device 102 receives external content. External content may be obtained in the manner described above with reference to FIG. 2A.

In step 302 the content is passed to the text analyzer 115, which processes the content to derive data comprising contextually significant words or phrases—as described above with reference to FIG. 2B.

In step 303 the content, words, and phrases are stored in the document repository 118 and database 119.

In step 304 the contextually significant words or phrases are transmitted to the consultant interface 121, the most significant of which are displayed in the form of a text map.

The resulting visualization of the significant words enables a clear identification of how the implicit cognition of the entity is reflected in the content presented to external stakeholders, and where this is misaligned from the entity's desired position. In some cases, leadership of an entity can be reticent to accept the findings of a business consultant. However, the present invention assists in breaking this resistance down by presenting the findings in the form of words generated by the entity itself, which cannot be denied.

It should be appreciated that a similar process may be applied to internal content to identify the alignment of such content with the culture the entity wishes to instill or maintain.

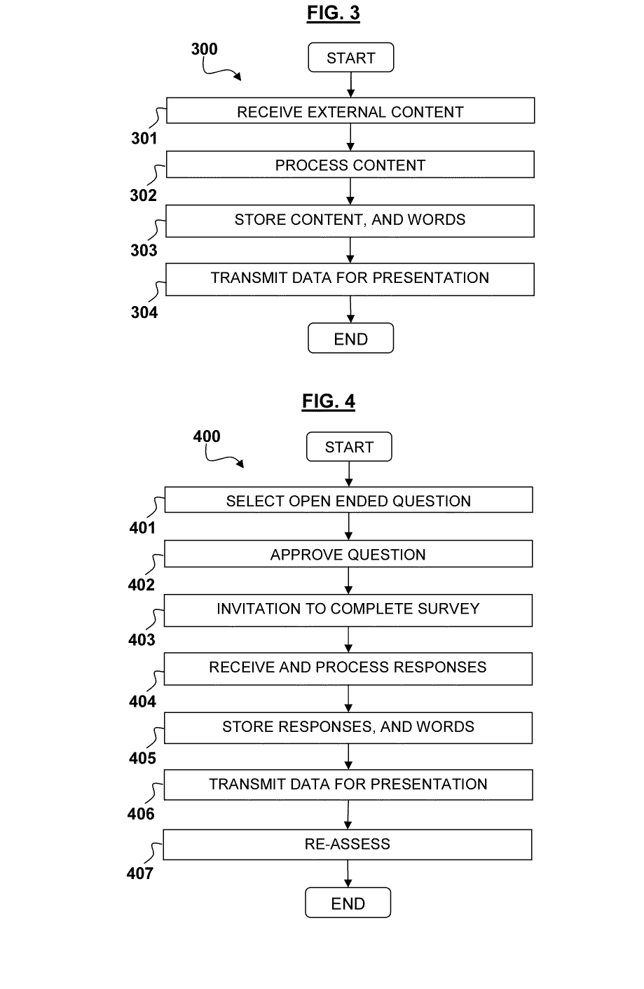

FIG. 4 shows a process flow 400 of the present invention for enabling assessment of alignment of an entity's desired perception of culture by internal stakeholders.

In step 401, at least one open ended question is selected from a set of questions encouraging a respondent to provide their description of perception or experience of an area of interest, avoiding leading the respondent to a particular answer. The area of interest relates to one of experience, environment, communication, leadership, loyalty, advocacy, purpose, or view of future (for example as it relates to optimism or pessimism).

The identity of the entity inserted into an identification field within the question before presentation to an analyst and the entity for approval in step 402.

On receiving approval, the target stakeholders are contacted with an invitation to complete an online survey hosted by the survey manager 112 in step 403.

In step 404 the analysis server device 102 receives responses to the questions, and passes these to the text analyzer 115. The responses are processed to derive data comprising contextually significant words or phrases—as described above with reference to FIG. 2B.

In step 405 the responses, words, and phrases are stored in the document repository 118 and database 119.

In step 406 the contextually significant words or phrases are transmitted to the consultant interface 121, the most significant of which are displayed in the form of a context map.

The contextually significant words reflect how internal stakeholders perceive the entity and their roles within it, which reflects actual culture—not simply the desired values or vision statement set by management. This may be correlated with the analysis of internal content to assess the influence of the content on the internal stakeholders' perceptions. Demographic information may be accessed and used for explanation where context is divergent.

In step 407, the same question is presented to stakeholders at a later date, and steps 404 to 406 repeated to derive a current set of contextually significant words or phrases for comparison with previous data and assess the significance of any differences.

It should be appreciated that a similar process may be applied to responses from external stakeholders to identify the alignment of the entity's desired brand perception with actual perception.

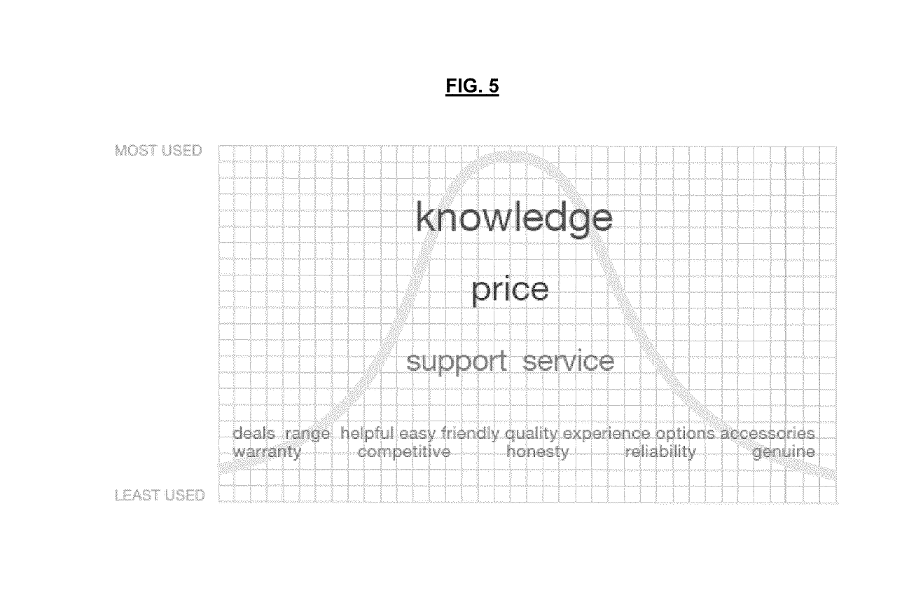

FIG. 5 illustrates a context map of contextually significant words and phrases identified within responses from customers to the question: “What do you consider important when buying a [BRAND] computer from a retailer? Please use at least five words or phrases and explain why you chose them.”

Respondents saw ‘knowledge’ as the most important consideration. They expected staff to be courteous, ‘helpful’ and ‘friendly’, but also honest in their assessment of a product and its suitability for a customer,

When it comes to receiving advice from the retail staff the respondents expected much more than simply the kind of knowledge available through reading the brochure. They wanted the staff to know the products (hardware and software) inside out. This extends beyond applications to things like connectivity and compatibility. In essence they expected retail staff that specialize in the [BRAND] product and are able to demonstrate that specialization on the spot—both physically and intellectually.

This expectation also informs the ‘service’ and ‘support’ requirements of the respondents. They expected to be able to test-drive the product and be looked after by people who are not there to sell [BRAND] to them but rather to help them get the best out of the [BRAND]. Getting the best out of the [BRAND] in this context means getting questions, concerns and minor problems addressed immediately and with no additional cost to the customer. There is a strong requirement for a very high standard of service that is above and beyond what they could expect from another non-specialist retailer and certainly well beyond anything that could be received online.

Respondents also expected to be able to see the entire range of [BRAND] product available in store both for demonstration and delivery. Failure to respect the importance of ‘availability’ and ‘range’ is enough in and of itself to make customers leave the store before they have even had a chance to experience any aspect of the service. Range also extends to ‘accessories’. Respondents expected to be able to accessorize their [BRAND] products in-store and as with the [BRAND] products themselves they want to see a large choice available to them. This is connected with the expectation of ‘knowledge’ from store employees—it is not enough to be able to demonstrate a knowledge of [BRAND] products and what a customer might require to meet their needs they must also be able to provide a complete solution that includes items such as cases, bags, peripherals and the like. In short, respondents wanted to be able to find everything they might reasonably need within the store. Their attitude is ‘if you don't have everything I need right now then I might as well order online.’

In addition, a major reason to shop with a retailer is to have somewhere to take the product to receive support and assistance should something go wrong. This support, like everything else in-store, needs to be ‘easy’ and accessible. Respondents complain that such support is often not forthcoming or that they are made to feel somehow responsible for product failures. Many see this area of support as one of the primary ways that a retailer can distinguish themselves from [BRAND] but lament that no one focuses on this area of the business or gives it due attention. The importance of standing behind the product and fulfilling the terms of the ‘warranty’ or even going above and beyond those terms cannot be underestimated.

The final major area of importance identified by the respondents as important is ‘price’. Respondents expect the price to at least match what is available from the [BRAND] online. Beyond this they expect ‘deals’ and ‘options’ that [BRAND] either do not, or cannot provide. Specifically respondents expect to be able to source deals from their retailer that reflect discounts for bulk or combination purchases and financing options that allow them to amortize the cost of their [BRAND] products.

Aspects of the present invention have been described by way of example only and it should be appreciated that modifications and additions may be made thereto without departing from the scope thereof as defined in the appended claims.

What we claim is:

1. A method of enabling assessment of alignment of an entity, comprising:
receiving content associated with the entity and comprising text;
receiving responses to questions presented to stakeholders of the entity;
processing the content and responses to derive data sets comprising contextually significant words or phrases for the content and responses respectively; and
correlating the contextually significant words or phrases of the respective data sets and outputting a correlated set of contextually significant words or phrases.

2. The method of claim 1, wherein receiving the content comprises obtaining the content.

3. The method of claim 2, wherein obtaining the content comprises includes crawling computer storage of the entity.

4. The method of claim 2, wherein obtaining the content comprises accessing websites.

5. The method of claim 1, comprising the step of differentiating between internal and external content.

6. The method of claim 1, wherein receiving the responses comprises receiving the responses from online questionnaires.

7. The method of claim 1, wherein processing the content and responses to derive the data sets comprising the significant words or phrases comprises one or more analytical or filtering processes comprising: sentence analysis, stop word filtering, synonym filtering, word stemming, sentiment analysis, part of speech analysis, tone of comments analysis, document importance analysis, and position in document analysis.

8. The method of claim 7, wherein deriving the contextually significant words or phrases comprises application of Bayesian contextual analysis after at least one iteration of the analytical or filtering processes.

9. The method of claim 8, wherein the Bayesian contextual analysis trains the analytical and filtering processes after each iteration.

10. The method of claim 1, comprising storing each word or phrase with identification of their origin and date of creation.

11. The method of claim 1, comprising application of the theory of diminishing returns to ensure that all significant words have been included.

12. The method of claim 1, comprising determining significance utilising Spearman's rank correlation coefficient.

13. The method of claim 1, comprising outputting the correlated set of statistically significant words or phrases in the form of a text map.

14. The method of claim 1, comprising assessing readability of the content.

15. A system enabling assessment of alignment of an entity, comprising:
a description importing module configured to receive content associated with the entity comprising text;
an attitude importing module configured to receive responses to questions presented to stakeholders of the entity;
a text analyzer module configured to process the content and responses to derive data sets comprising contextually significant words or phrases for the content and responses respectively; and
an alignment assessment module configured to correlate the significant words or phrases of the respective data sets and output a correlated set of significant words or phrases.

16. An article of manufacture having computer storage medium storing computer readable program code executable by a computer to implement a method of enabling assessment of alignment of an entity, comprising:
computer readable program code receiving content associated with the entity and comprising text;
computer readable program code receiving responses to questions presented to stakeholders of the entity;
computer readable program code processing the content and responses to derive data sets comprising contextually significant words or phrases for the content and responses respectively; and
computer readable program code correlating the significant words or phrases of the respective data sets and outputting a correlated set of significant words or phrases.

17. A method of enabling assessment of alignment of an entity's desired brand representation with its external content, comprising:
receiving external content associated with the entity comprising text;
processing the content to derive a data set comprising contextually significant words or phrases for the content; and
outputting the data set.

18. The method of claim 17, wherein processing the content to derive the data set comprising the significant words or phrases comprises one or more analytical or filtering processes comprising: sentence analysis, stop word filtering, synonym filtering, word stemming, sentiment analysis, part of speech analysis, tone of comments analysis, document importance analysis, and position in document analysis.

19. The method of claim 18, wherein deriving the contextually significant words or phrases comprises application of Bayesian contextual analysis after at least one iteration of the analytical or filtering processes.

20. The method of claim 19, wherein the Bayesian contextual analysis trains the analytical and filtering processes after each iteration.

21. The method of claim 17, comprising evaluating readability of the content prior to processing.

22. A system enabling assessment of alignment of an entity's desired brand representation with its external content, comprising:
a description importing module configured to receive external content associated with the entity comprising text;
a text analyzer module configured to process the content to derive a data set comprising contextually significant words or phrases for the content; and
an alignment assessment module configured to output the data set.

23. An article of manufacture having computer storage medium storing computer readable program code executable by a computer to implement a method of enabling assessment of alignment of an entity's desired brand representation with its external content, comprising:
computer readable program code receiving external content associated with the entity comprising text;
computer readable program code processing the content to derive a data set comprising contextually significant words or phrases for the content; and
computer readable program code outputting the data set.

24. A method of enabling assessment of alignment of an entity's desired culture with its internal content, comprising:
receiving internal content associated with the entity comprising text;
processing the content to derive a data set comprising contextually significant words or phrases for the content; and
outputting the data set.

25. The method of claim 24, wherein processing the content to derive the data set comprising the significant words or phrases comprises one or more analytical or filtering processes comprising: sentence analysis, stop word filtering, synonym filtering, word stemming, sentiment analysis, part of speech analysis, tone of comments analysis, document importance analysis, and position in document analysis.

26. The method of claim 25, wherein deriving the contextually significant words or phrases comprises application of Bayesian contextual analysis after at least one iteration of the analytical or filtering processes.

27. The method of claim 26, wherein the Bayesian contextual analysis trains the analytical and filtering processes after each iteration.

28. The method of claim 24, comprising evaluating readability of the content prior to processing.

29. A system enabling assessment of alignment of an entity's desired culture with its internal content, comprising:
a description importing module configured to receive internal content associated with the entity comprising text;
a text analyzer module configured to process the content to derive a data set comprising contextually significant words or phrases for the content; and
an alignment assessment module configured to output the data sets.

30. An article of manufacture having computer storage medium storing computer readable program code executable by a computer to implement a method of enabling assessment of alignment of an entity's desired brand representation with its external content, comprising:
computer readable program code receiving internal content associated with the entity comprising text;
computer readable program code processing the content to derive a data set comprising contextually significant words or phrases for the content; and
computer readable program code outputting the data set.

31. A method of enabling assessment of alignment of an entity's desired perception of brand or culture with perception by stakeholders, comprising:
receiving responses to questions presented to stakeholders of the entity;
processing the responses to derive a data set comprising contextually significant words or phrases for the responses; and
outputting the data set.

32. The method of claim 31, wherein the question comprises an open ended question encouraging the stakeholders to provide their description of perception or experience of an area of interest.

33. The method of claim 32, wherein the area of interest comprises one of: experience, environment, communication, leadership, loyalty, advocacy, purpose, or view of future.

34. The method of claim 33, wherein the question is selected from a set of questions covering the range of areas of interest.

35. The method of claim 34, wherein the question to be presented is selected based on the area of interest for assessment, and the identity of the entity inserted into an identification field within the question before presentation to stakeholders.

36. The method of claim 31, comprising presenting the same question to stakeholders at a later date, and the responses processed to derive a current set of contextually significant words or phrases.

37. A system enabling assessment of alignment of an entity's desired perception of brand or culture with perception by stakeholders, comprising:
an attitude importing module configured to receive responses to questions presented to stakeholders of the entity;
a text analyzer module configured to process the responses to derive a data set comprising contextually significant words or phrases for the responses; and
an alignment assessment module configured to output the data sets.

38. An article of manufacture having computer storage medium storing computer readable program code executable by a computer to implement a method of enabling assessment of alignment of an entity's desired perception of brand or culture with perception by stakeholders, comprising:
computer readable program code receiving responses to questions presented to stakeholders of the entity;
computer readable program code processing the responses to derive a data set comprising contextually significant words or phrases for the responses; and
computer readable program code outputting the data set.
